(19) United States
(12) Patent Application Publication
(10) Pub. No.: US 2016/0098786 A1
(43) Pub. Date: Apr. 7, 2016

(54) REAL ESTATE TRANSACTION SYSTEM

(71) Applicant: Brian Latimer, St. Charles, IL (US)

(72) Inventor: Brian Latimer, St. Charles, IL (US)

(21) Appl. No.: 14/507,399

(22) Filed: Oct. 6, 2014

(51) Int. Cl. G06Q 30/06

(52) U.S. Cl. CPC G06Q 30/0645; G06Q 50/16

(57) ABSTRACT

A computerized real estate transaction system is provided. The system allows prospective tenants to coordinate showings of apartments directly with the current tenants, eliminating the need for a real estate agent to tour the prospective tenant around, and allowing the prospective tenant to choose the apartments they view. A real estate agent may be engaged for the limited work of coordinating and executing the lease.

### BACKGROUND OF THE INVENTION

1. Field of the Invention

The present invention relates generally to a rental real estate transaction system. More particularly the present invention relates to a computerized system that allows tenants and prospective renters to coordinate viewing, utilizing a real estate agent only when engaging in a rental agreement with a landlord.

2. Description of Related Art

In many rental real estate markets, particularly in cities, there are a number of inefficiencies in the processes involved that make the rental process more costly and difficult than is required. Initially, most prospective renters, or groups of renters, begin their search online through several popular websites, all of which are used by local real estate agents to advertise available real estate.

The prospective renters may then submit an inquiry through such websites. Consumers often contact several different real estate agents regarding several different properties in the process. Most of the same apartments advertised online are in fact advertised by several, if not dozens of, real estate agents in the area. In addition, anyone who has ever searched for an apartment online can attest to the fact that listings posted online are, in many cases, no longer actually available.

Once a consumer has successfully contacted and communicated with a real estate agent (or several) in the area, they arrange a meeting. The consumer meets the real estate agent to view properties within their specified criteria. Typically, consumers meet with several different agents with several different offices and can spend weeks, even months, on the search process.

A further major source of market inefficiency is the lack of paying consumers that interact with real estate agents throughout the search process. A consumer is not charged any fees associated with a rental transaction until a contract is generated and that consumer has in fact decided to procure a transaction with a particular real estate agent. Due to the lack of financial commitment and obligation of consumers, many consumers will often spend time with real estate agents who they never compensate. The real estate agent relies on the occasional converted consumer to generate enough revenue to recompense time lost with consumers that do not become paying clients.

Put simply, consumers who actually end up financially compensating real estate agents end up compensating agents for not only the time they personally spent with that particular agent, but also for the time that non-paying consumers spent with that agent as well. Broker fees associated with rental transactions are abnormally high in cost, and if they were not as high in cost, real estate agents would not be incentivized enough to remain in the market.

Moreover, popular apartments that tenants do not choose to renew leases in popular areas are placed on the open rental market as early as 9 months prior to the expiration of that current tenant's lease. With some units remaining on the market for several months before a replacement tenant is found, rental units in these popular areas may be shown to prospective tenants dozens of times per week, by dozens of real estate agents operating in the area. Tenants often complain of privacy invasion, lack of notification of scheduled showings, and excessive scheduled showings, among other complaints. In extreme cases, some tenants suffer property loss in the effects of theft by strangers entering their apartments with little to no recording required.

Thus, consumers are forced to pay high broker fees to real estate brokerages due to a simple lack of available real-time information. Real estate agents are able to reasonably justify charging extreme fees to paying consumers to compensate for their interactions with non-paying consumers. Broker fees are by nature high in cost and do not correlate based on value experienced by a consumer. Further still, existing tenants are put in a difficult position because of frequent intrusions.

Therefore, what is needed is a rental real estate transaction system that may provide more direct control to tenants and prospective tenants, by allowing their direct communication, using the real estate only for the lease execution phase of the rental process.

### SUMMARY OF THE INVENTION

The subject matter of this application may involve, in some cases, interrelated products, alternative solutions to a particular problem, and/or a plurality of different uses of a single system or article.

In one aspect, a method of renting an apartment using a computerized real estate transaction system is provided. The method may begin with the step of a user signing up for the system. This user may be a prospective tenant wishing to search for and view apartments. The signing up may involve the inputting of a quantity of biographical information, and inputting a quantity of rental requirement information. This input information is communicated by the prospective tenant's computer to a server of the computerized real estate transaction system.

Based on the input information, the user may be signed up and may have a plurality of apartment listings displayed on their computer based on a communication from the system server. The prospective tenant user may select one or more apartments that they wish to view through their computer's interface. The selected apartment(s) is transmitted to the system server by the prospective tenant computer as a viewing request. This request may then be sent from the system server to an existing tenant's computer, and the existing and prospective tenants may coordinate a viewing. Once the viewing is coordinated, the prospective tenant may pay a viewing fee to the system using his computer.

Once the prospective tenant has found an apartment he or she wishes to rent, the desired apartment may be selected through the interface of the prospective tenant computer. The computer may then communicate this rental request to the system server. Upon receipt of the rental request, the system server may contact a real estate agent, who may in turn generate the required lease and other documents, coordinate with the prospective tenant, and execute the lease.

In another aspect, a computerized real estate transaction system is provided. The system may involve at least a prospective tenant computer, system server, existing tenant computer, and real estate agent computer. These computers and server may be in networked communication, and are configured to provide the functionality of the real estate transaction system. The prospective tenant computer is configured to provide input information regarding the desired apartment of the prospective tenant. This information may be transmitted to the server and in response, the server may provide apartment listing corresponding to the desired apartment requirements.

The prospective tenant may then select an apartment for viewing using the prospective tenant computer. The prospective tenant computer may communicate to the server, which in turn may contact the existing tenant of the apartment through the existing tenant's computer. The prospective tenant and existing tenant may then communicate, either directly through their computers, or through the system server, to coordinate a showing date and time. The prospective tenant submits a payment to the system server, and the apartment may be viewed.

Once the prospective tenant has viewed an apartment that they wish to rent, they may submit a rental request using their computer to the system server. The system server may record this rental request and may then contact a real estate agent computer with the rental request. The prospective tenant and real estate agent may then communicate, either directly through their computers, or through their computers to the system server, to coordinate and execute a lease and related papers. The prospective tenant submits a payment to the system server, for the lease preparation and execution, and the apartment may be leased.

### BRIEF DESCRIPTION OF THE DRAWINGS

FIG. 1 provides a schematic data flow view of an embodiment of the present invention.

FIG. 2 provides a flow chart of an embodiment of the present invention.

FIG. 3 provides a flow chart of another embodiment of the present invention.

FIG. 4 provides a flow chart of still another embodiment of the present invention.

### DETAILED DESCRIPTION

The detailed description set forth below in connection with the appended drawings is intended as a description of presently preferred embodiments of the invention and does not represent the only forms in which the present invention may be constructed and/or utilized. The description sets forth the functions and the sequence of steps for constructing and operating the invention in connection with the illustrated embodiments.

Generally, the present invention concerns a computerized system that allows prospective tenants (consumers) to engage with existing tenants in apartments the consumers may wish to rent. The system allows a prospective tenant to access apartments for rent matching their criteria, and to tour these apartments after paying a fee per apartment viewing. Similarly, those moving out of an apartment may post their apartments for viewing and may receive compensation for this viewing. Once a prospective tenant identifies an apartment that they would like to rent, the system may contact an agent who may facilitate the transaction, ensure legitimacy, and execute the lease agreement. This system may be coordinated by one or a plurality of computers in electronic communication with each other. The computer may automatically coordinate prospective tenant, tenant resident, and agent sides to facilitate the transaction. The computer may further be utilized to carry out additional steps of the method including generating potential apartment matches for a prospective tenant, evaluating the tenant for risk (such as by credit check, background check, rental history, renter rating, and the like). The system of the present invention comprises three interface aspects: The prospective tenant aspect, the tenant/resident aspect, and the real estate agent aspect. The present invention coordinates these three aspects, allowing communication and effective renting and transfer or rental properties, making rental real estate transactions more effective and profitable for all involved.

The present invention must be carried out on a computer or similar computing device. Such a device comprises a memory, a processor, and an input/output system such as, among other options, a touch screen display. Further, in some embodiments, the present invention comprises a non-transitory computer readable medium configured to instruct the computer or computing device to carry out the steps involved to execute and operate the system and inventions contemplated herein. Moreover, the various aspects of the present invention may be carried out by one or a plurality of modules (computerized, operational, or the like) to provide operability to the system. These modules may work together and be in communication with each other for carrying out the various steps of the methods and functions of the computerized system.

Turning now to the prospective tenant aspect, a computerized user interface is provided to the prospective tenant user. A new user begins by inputting a quantity of user information. This information may comprise biographical information, contact information, a photograph, and the like. Additional user information may include student enrollment status, age, course of study, employment, and the like. Further, the user may input geographical areas of interest for renting an apartment, a budget range, lease start date, and specific apartment requirements. These requirements may include number of bedrooms, size (square footage), number of bathrooms, amenities, and the like.

In varying additional embodiments, the user may further input additional information including social security number and information required for a credit check and/or a background check. Moreover, the user may input rent history and references. The computerized system may use this information to automatically generate a credit check, a background check, and/or automatically contact prior landlords. Based on this generated information, the computerized system may automatically generate a renter score or rating to allow the agent, and, optionally, a tenant to view before showing or renting the apartment. In one embodiment, only this rating may be accessible by an agent. In another embodiment, the rating may be accessible by an agent and a potential showing tenant.

Once a user has input their interest requirements, the computerized system may automatically generate a list of available apartments that fit the user's criteria. In one embodiment, the system may utilize a GPS mapped interface allowing the user's location to be displayed, and allowing the prospective apartments matching the criteria to be displayed on the map. The user may view details, and may select any apartments he or she may be interested in. Each apartment viewing may cost a flat fee to compensate the existing tenant. The computerized system may put the prospective tenant and existing tenant in communication to coordinate a showing date and time. Further the system may receive and process a payment, and may transfer at least a portion of that payment to the existing tenant.

After viewing an apartment that the prospective tenant wishes to rent, the prospective tenant may submit a rental request through the computerized system. The system may contact an authorized agent, and provide the agent with the prospective tenant user information, optional rating, and information on the apartment to be rented. The agent and prospective tenant may then coordinate a meeting and/or contact to execute the rental agreement.

Also after viewing, whether a prospective tenant wishes to rent or not, the prospective tenant user may rate the viewed apartment using the computerized system. This rating may be visible to other prospective tenant users, and optionally may be available to the tenant resident user.

The computerized system may record and document all showings, including the date, time, users, details on all attending the showing, and the like. This feature may provide additional safety and comfort for all involved.

Turning now to the tenant resident aspect, a computerized user interface may be provided to the tenant resident user. The tenant user may begin by inputting a quantity of user and apartment information. This information may comprise biographical information, contact information, a photograph, and the like. Additional user information may include student enrollment status, age, course of study, employment, and the like. The apartment information includes details of the apartment, as formatted by a questionnaire provided to the tenant user by the computerized interface of the system. The questionnaire includes questions regarding apartment location, apartment details such as size, amenities, features, tenant opinion and comments, and the like. The tenant user may also upload photographs taken of the apartment. The tenant may then activate or deactivate their apartment listing availability using the computerized interface. When the tenant user's apartment listing is activated through the computerized interface, prospective tenant users may see the listing and may request showings, as discussed above.

In a further embodiment, the computerized system may be configured to incentivize the tenant user to maintain their apartments in presentable condition using the rating system. If the tenant user's showings receive a certain number of negative reviews, and/or if the negative reviews are specifically for issues like cleanliness, tenant attitude, and the like, the tenant user may receive a warning notification from the computerized system. In a further embodiment, after one or a plurality of warnings, the tenant's unit may be removed from the computerized system database, or may be prevented from showing up in searches by prospective tenants. This removal may be communicated to the tenant user, and optionally the landlord.

Turning now to the real estate agent aspect, as with the other aspects, a computerized user interface may be provided to a prospective real estate agent. Upon application, the computerized system may automatically verify the agent's credentials (such as licensure status, review of complaints filed, years experienced, and the like). Alternatively, a system administrator may manually verify the agent's credentials. The real estate agent may also upload personal information such as a short bio, photograph, experience, interests and the like. The real estate agent user may have the ability to accept or deny lease signings at their discretion. Moreover, as the system grows, the system will be regulated to ensure that the group of qualified agents grows in correlation to the growth of demand.

Prospective tenant users may utilize the computerized system of the present invention to select and contact one of the agents in one embodiment. In another embodiment, the agent may be automatically assigned to the prospective tenant by the system. Once the request is sent to the agent, however they are found, the agent will receive a notification by the system on a computerized display in communication with the system. The notification will indicate that the prospective tenant is ready to sign a lease on the apartment, with the specific apartment details. The agent and prospective tenant may then arrange a meeting or otherwise communicate to sign and execute the lease and related transactions (security deposit, independent approval and/or credit check by agent, confirmation with and the like).

The computerized system may be configured to automatically populate a form lease based on information provided by the prospective tenant user. In this embodiment, a standard lease agreement, such as one provided by a state reality board or similar authority, may be configured by the system to include fields that may be automatically fillable and populatable from the prospective tenant user's account. For example, name, contact information, and the like may be automatically imported. After generation by the system, the lease may be reviewed and edited by the real estate agent to confirm it is correct, and to make any amendments as needed. In varying embodiments, the system may also produce additional paperwork, forms, and the like that may be required for the particular leased property. The agent and prospective tenant may meet or communicate electronically or by phone. The agent may explain the paperwork, answer questions, and provide guidance to the prospective tenant as needed, and then the lease may be executed.

To engage the agent for preparing the paperwork and executing the lease, the prospective tenant user may pay a flat fee, titled a “lease execution fee” or similar. This fee may go largely to the agent, with a smaller portion paid to the computerized system operator. For example, if the lease execution fee is $250, $200 may be paid to the real estate agent, while $50 may be paid to the computerized system operator.

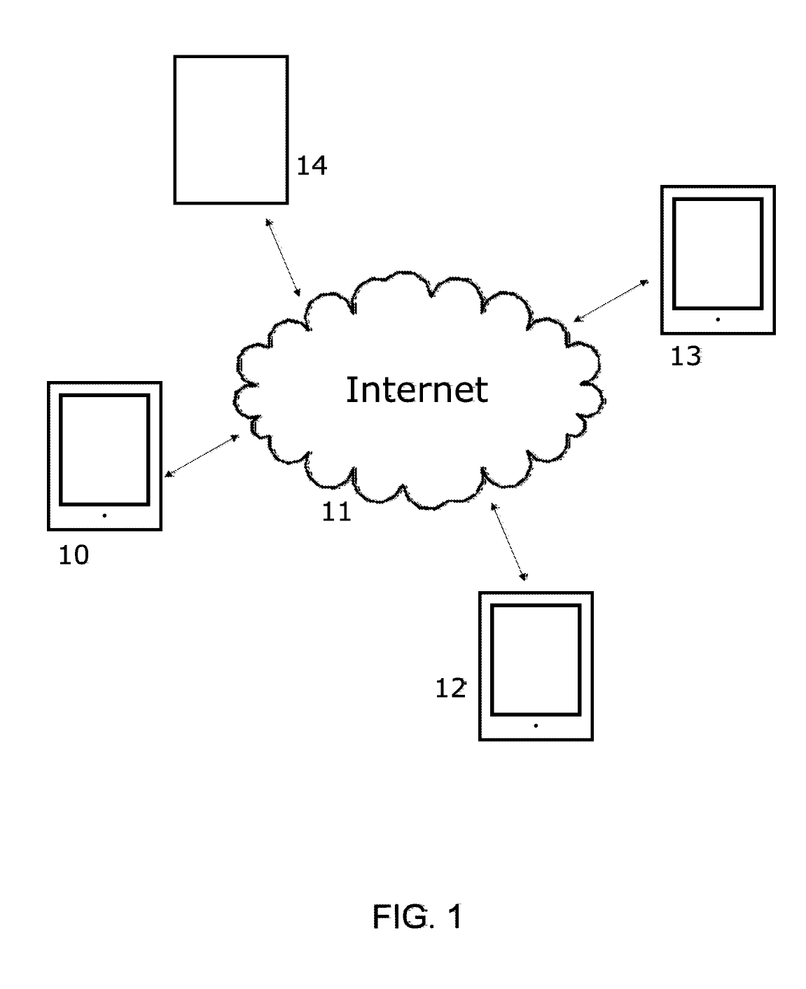

Turning now to FIG. 1, a data flow schematic view of an embodiment of the computerized system is provided. In this embodiment, three user computers (shown here as tablets, but as noted above, they may be any computerized devices) are in communication with an internet, and a system server. The computers shown are a prospective tenant computer 10; a current tenant computer 12; and a real estate agent computer 13. Each of these computers 10, 12, 13 are in communication with the internet and, using the system server 14, may be in communication with each other. The computers 10, 12, 13, are configured to operate as described above, to provide the operability of the computerized system to the different user computers. Information of the system including user information for each aspect, along with data allowing the system and its computers to operate as described is stored on server 14. In most embodiments of operation, the server 14 provides communication between the computers of the different users. For example, prospective tenant user's computer 10 may communicate with the server to view potential apartments. Once the user identifies an apartment, they may use their computer 10 to provide a request to the server 14 to contact the tenant user's computer 12. The server 14 may then send a signal and provide information to the tenant user's computer 12 to indicate that a prospective tenant wishes to view the tenant user's apartment.

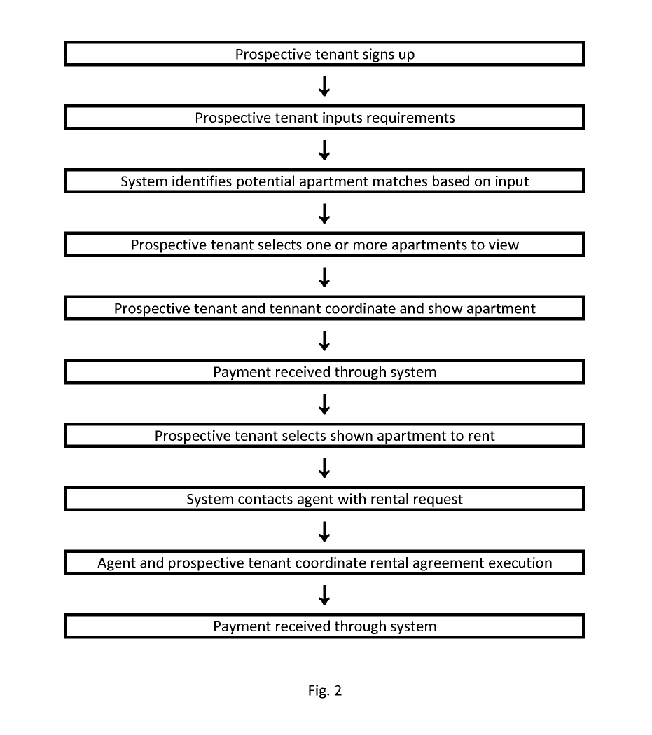

FIG. 2 shows a flow chart showing steps of an embodiment of a method of using the system. The steps of the embodiment shown demonstrate an embodiment of use for a prospective tenant user. The method begins with the prospective tenant user signing up for the computerized system. This signing up includes the step of a consumer inputting their information and apartment requirements. The system is then configured to search the system database for apartments fitting the input requirement and to display these apartment listings to the prospective tenant user. The user may then select one or more apartments to view. The current tenants of the selected apartments will receive a notification through their computer in communication with the server of the system, and the tenant and prospective tenant may coordinate a time to show the apartment. The prospective tenant may then pay the apartment viewing fee using his computer through the computerized system, and then view the apartment.

After seeing one or more apartments, once the prospective tenant finds an apartment he or she would like to rent, the prospective tenant may use their computer to communicate a rental intent on a particular apartment. This intent request is sent to the computerized system server, which in turn contacts an agent. The agent may be automatically selected, or may be selected by the prospective tenant, current tenant, and/or real estate agent, depending on embodiment.

Once the agent is contacted, the agent and prospective tenant coordinate the signing and execution of the lease and related paperwork. Further, the prospective tenant pays the agent a lease execution fee. This payment is received and processed through the computerized system in a similar manner as the prospective tenant pays the tenant user.

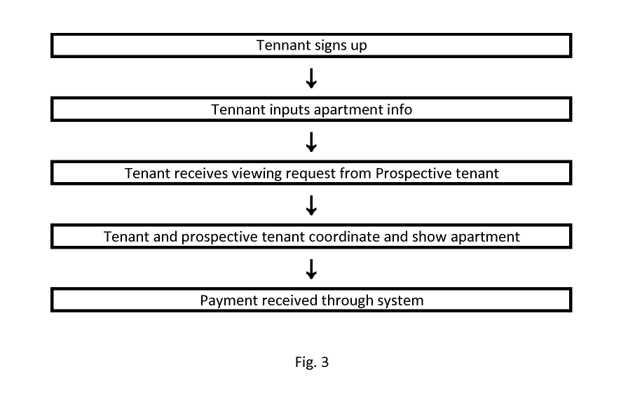

FIG. 3 provides a flow chart of steps involved for a tenant user operation. Initially, the tenant occupying an apartment who anticipates moving may sign up for the system. This signing up step may be through a computer of the tenant communicating with the server of the system. In signing up, the tenant inputs the apartment information into a questionnaire or similar structured input form. This information may be stored in the system server to be accessed by prospective tenant.

When a prospective tenant wishes to view the tenant's apartment, the tenant will receive a viewing request on a display of the tenant computer. Upon receipt, the tenant and prospective tenant coordinate through electronic communication to set up a date and time for the viewing, and the tenant may receive payment through the computerized system. This payment may go to an account, or may be directly transferred to a user's bank account.

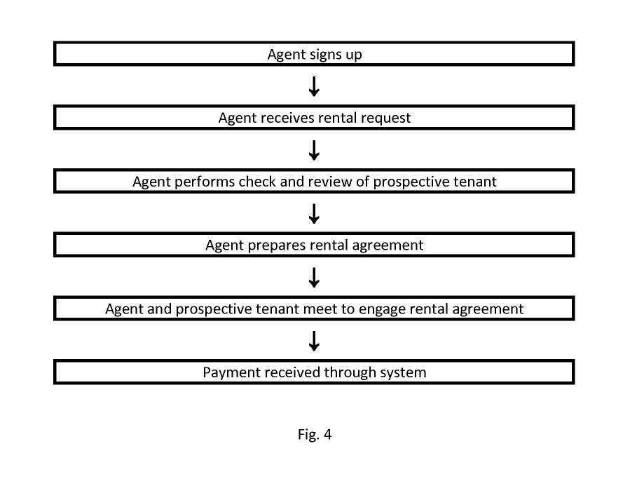

FIG. 4 provides a flow chart of steps involved for an agent user operation. Initially, a real estate agent interested in utilizing the computerized system may sign up for the system. The agent inputs a quantity of information including personal and bio information, license information, and the like. Once the agent is signed up and verified by the system, they may begin receiving lease execution requests. This request will include the details required for the lease and other paperwork preparation. In some embodiments, these documents (lease and others) may be automatically populated and generated by the computerized system. Once prepared, the agent and prospective tenant may coordinate a date and time to meet or otherwise be in communication to sign and execute the lease. The agent may receive the lease execution fee payment, and the real estate transaction system may be completed.

While several variations of the present invention have been illustrated by way of example in preferred or particular embodiments, it is apparent that further embodiments could be developed within the spirit and scope of the present invention, or the inventive concept thereof. However, it is to be expressly understood that such modifications and adaptations are within the spirit and scope of the present invention and are inclusive of, but not limited to, the following appended claims as set forth.

What is claimed is:

1. A method of renting an apartment using a computerized real estate transaction system comprising the steps of:
signing up for the system by a prospective tenant using a prospective tenant computer, the signing up comprising the steps of inputting a quantity of biographical information and inputting a quantity of rental requirement information;
communicating the input biographical information and rental requirement information to a system server computer from the prospective tenant computer;
identifying a plurality of apartment listings on the system server corresponding to the input rental requirements;
receiving, from the system server by the prospective tenant computer, a list of available apartments meeting the input rental requirement information, the list being displayed on a display of the prospective tenant computer;
selecting at least one apartment to view by the prospective tenant using the prospective tenant computer;
transmitting the selected at least one apartment request to the system server by the prospective tenant computer;
coordinating, through the prospective tenant computer, a showing with an existing tenant, the prospective tenant computer communicating with the existing tenant through the system server;
sending a payment for viewing the at least one apartment using the prospective tenant computer, the sent payment information being received and processed by the system server;
selecting a viewed apartment to rent by the prospective tenant user using the prospective tenant computer after viewing the viewed apartment, the step of selecting comprising the prospective tenant computer communicating to the system server;
coordinating, through the prospective tenant computer, a lease execution with an agent authorized by the real estate transaction system; and
sending a payment for the execution of the lease using the prospective tenant computer, the sent payment information being received and processed by the system server.

2. The method of claim 1 further comprising the step of inputting a review of the viewed apartment after the viewing of the apartment using the prospective tenant computer.

3. The method of claim 1 further comprising the step of inputting a review of the real estate agent after the execution of the lease using the prospective tenant computer.

4. The method of claim 1 wherein the list of apartments is displayed on a map on the display of the prospective tenant computer.

5. The method of claim 1 wherein the quantity of biographical information comprises information sufficient to perform a credit check; wherein the system server performs a credit check; and the step of receiving and displaying information representing the results of the credit check by the prospective tenant computer.

6. A computerized real estate rental transaction system comprising:
a system server, the system server being a computer in electronic communication with a network, and comprising a database containing information and records received and processed by the system, the system server configured to receive and send communications to provide operation to the system;
a prospective tenant computer in communication with the system server;
an existing tenant computer in communication with the system server; and
a real estate agent computer in communication with the system server;
wherein the prospective tenant computer is configured to carry out the steps of:
signing up for the system by a prospective tenant using a prospective tenant computer, the signing up comprising the steps of inputting a quantity of biographical information; and inputting a quantity of rental requirement information;
communicating the input biographical information and rental requirement information to a system server computer from the prospective tenant computer;
identifying a plurality of apartment listings on the system server corresponding to the input rental requirements;
receiving, from the system server by the prospective tenant computer, a list of available apartments meeting the input rental requirement information, the list being displayed on a display of the prospective tenant computer;
selecting at least one apartment to view by the prospective tenant using the prospective tenant computer;
transmitting the selected at least one apartment request to the system server by the prospective tenant computer;
coordinating, through the prospective tenant computer, a showing with an existing tenant, the prospective tenant computer communicating with the existing tenant through the system server;
sending a payment for viewing the at least one apartment using the prospective tenant computer, the sent payment information being received and processed by the system server;
selecting a viewed apartment to rent by the prospective tenant user using the prospective tenant computer after viewing the viewed apartment, the step of selecting comprising the prospective tenant computer communicating to the system server;
coordinating, through the prospective tenant computer, a lease execution with an agent authorized by the real estate transaction system; and
sending a payment for the execution of the lease using the prospective tenant computer, the sent payment information being received and processed by the system server;
wherein the system server is configured to carry out the steps of:
receiving input from the prospective tenant computer, the input comprising the quantity of biographical information, the rental requirements information, the viewing request, and the rental request;
communicating to the tenant computer the viewing request after receiving the viewing request from the prospective tenant computer;
communicating to the real estate agent computer the rental request;
processing and distributing the viewing payment by sending a portion of the viewing payment to the tenant;
processing and distributing the payment for the executing of the lease by sending a portion of the payment to the real estate agent; and
recording the viewing and rental requests to a system database stored on the system server;
wherein the tenant computer is configured to carry out the steps of:
receiving the viewing request of the prospective tenant from the system server;
receiving a payment notice upon the receipt of payment from the prospective tenant; and
communicating automatically to the system server information about the scheduled viewing, the information comprising the date, time, and the biographical information of the prospective tenant;
wherein the real estate agent computer is configured to carry out the steps of:
receiving the rental request of the prospective tenant from the system server;
receiving a payment notice upon the receipt of payment from the prospective tenant; and
communicating automatically to the system server information about the lease execution, the information comprising the biographical information of the prospective tenant involved in the lease execution, a date of lease execution, and a content of the lease.

7. The system of claim 6 wherein the system server is further configured to carry out the steps of:
receiving a review of the viewed apartment by the prospective tenant;
receiving a review of the real estate agent by the prospective tenant; and
displaying the review of the viewed apartment and review of the real estate agent.

8. The system of claim 6 wherein the quantity of biographical information input by the prospective tenant comprises information sufficient to perform a credit check; wherein the system server is configured to perform a credit check; and wherein the prospective tenant computer is configured to carry out the step of receiving and displaying information representing the results of the credit check by the prospective tenant computer.

9. The system of claim 6 wherein the quantity of biographical information comprises a name, age, photograph, and employment status.

10. The system of claim 6 wherein the quantity of rental requirement information comprises a budget, number of bedrooms, number of bathrooms, and amenities.

11. The system of claim 6 wherein the real estate agent computer is further configured to carry out the steps of:
signing up for the system by the real estate agent, the signing up comprising the steps of inputting a quantity of biographical information; and inputting a real estate license information; and
communicating the input biographical information and real estate license information to the system server computer from the real estate agent computer.

12. The system of claim 11 wherein the system server is configured to automatically verify the status of the real estate license information of the real estate agent.

13. The system of claim 6 wherein the system server is configured to automatically perform a background check based on the input biographical information of the prospective tenant.

14. The system of claim 6 wherein the input biographical information of the prospective tenant comprises a rental history.

15. The system of claim 6 wherein the input rental requirement information of the prospective tenant comprises a geographic area.

16. The system of claim 6 wherein a scheduling of the viewing of the apartment is performed by communication by the prospective tenant computer and the tenant computer, and without the real estate agent computer.

17. The system of claim 6 wherein the prospective tenant computer, tenant computer, and real estate agent computer are in communication with the system server using an internet connection.

18. The system of claim 6 wherein the system server automatically selects the real estate agent computer once receiving the rental request.

19. The system of claim 6 wherein the rental request comprises a real estate agent selection.

20. The system of claim 6 wherein the system server is configured to automatically generate a form lease based on the prospective tenant biographical information, and configured to send the automatically generated form lease to the real estate agent computer.
